(19) United States
(12) Patent Application Publication
(10) Pub. No.: US 2017/0180461 A1
(43) Pub. Date: Jun. 22, 2017

(54) SYSTEM AND METHOD FOR AUTOMATICALLY INITIATING AN INTEGRATED VIRTUAL PRIVATE NETWORK CONNECTION FOR ESTABLISHING A COMMUNICATIONS SESSION

(71) Applicants: Garry Paxinos, Pompano Beach, FL (US); Anastasios Kyriakides, Hollywood, FL (US); Anastasios Nicholas Kyriakides, II, Plantation, FL (US); Kenneth Hosfeld, Coral Springs, FL (US); Alain Gonzalez, Miami, FL (US); Marcelo Gabriel Matews, Boca Raton, FL (US); Daniel Delgado, Miami, FL (US)

(72) Inventors: Garry Paxinos, Pompano Beach, FL (US); Anastasios Kyriakides, Hollywood, FL (US); Anastasios Nicholas Kyriakides, II, Plantation, FL (US); Kenneth Hosfeld, Coral Springs, FL (US); Alain Gonzalez, Miami, FL (US); Marcelo Gabriel Matews, Boca Raton, FL (US); Daniel Delgado, Miami, FL (US)

(21) Appl. No.: 15/384,290

(22) Filed: Dec. 19, 2016

Related U.S. Application Data
(60) Provisional application No. 62/269,883, filed on Dec. 18, 2015.

(51) Int. Cl. H04L 29/08; H04L 12/46

(52) U.S. Cl. CPC H04L 67/10; H04L 12/4641; H04L 67/14; H04L 67/02

(57) ABSTRACT

A system and method for initiating a VPN connection for the purposes of establishing an indirect connection to a network resource through the VPN includes an initiation device, an end target, and a VPN server. The process through which a VPN connection is initiated in order to establish a connection to a network destination through the VPN begins with the initiation device being directed to or otherwise attempting the access a target network destination. This connection attempt is then held, either because the destination is blocked or because it defines a secure address that requires a secure connection. Then, the initiation device contacts a VPN server and establishes a connection to the VPN server's network. Once connected to the VPN server's network, the initiation device allows the connection to be made to the target network destination through the initiation device's connection the VPN server's network.

### CROSS REFERENCE TO RELATED APPLICATIONS

This application claims the benefit of and incorporates by reference co-pending U.S. provisional patent application Ser. No. 62/269,883 filed Dec. 18, 2015.

### BACKGROUND OF THE INVENTION

Field of the Invention

This invention relates generally to establishing communications sessions and, more particularly, to a system and method for automatically initiating an integrated virtual private network connection to establish a desired communications session.

Description of the Prior Art

It is well established that for some communications protocols, the ability of a user to access to certain ports or addresses from a network enabled device on a particular network may be limited through network controls beyond the user's control. For example, it is common for access to session initiation protocol (“SIP”) ports to be blocked by a firewall or router as controlled by a local network administrator such as a coffee shop or hotel. In some cases, such ports or other addresses may be blocked on a larger scale by an Internet Service Provider under the control or at the behest of a jurisdictional authority (i.e., a government).

Therefore, a problem which exists is that if access to a particular desired communications protocol has been blocked on the network a user is connected to, there is typically no recourse for the user to access the data or services available on the desired communications protocol. Thus, there remains a need for a system and method that would enable a user to access a port or address that has been blocked on the network the user is presently connected to.

The use of virtual private networks (“VPN”), to directly connect a network enabled device that is connected to a public network, such as the Internet, to a private network as if it were directly connected to the private network is well known. VPNs, which are created by establishing a virtual point-to-point connection, essentially extending the private network across the public network for such a network enabled device. By connecting to the private network in this manner, the network enabled device is able to access the features and data available to the private network while benefiting from the functionality, speed, economy, and management policies of the public network.

Accordingly, what is needed is a system and method for automatically establishing a virtual point-to-point connection with a remote server when a desired port or network address has been blocked for the purposes of establishing a connection to the desired port or address or for the purpose of securing the both the metadata of the communication as well as the actual media stream (audio and optionally video and other data).

The Applicant's invention described herein provides for a system and method for automatically initiating a VPN connection for the purposes of establishing a connection to a blocked resource and/or securing the communication through the VPN. When in operation, the system and method, upon detecting an access restrictions on a network for a desired end point, enables the automatic establishment of a VPN connection through which it can avoid detected access restrictions. As a result, many of the limitations imposed by prior art systems are removed.

### SUMMARY OF THE INVENTION

A system and method for initiating a VPN connection for the purposes of establishing an indirect connection to a network resource through the VPN includes an initiation device, an end target, and a VPN server. In an exemplary embodiment, the initiation device may define a conventional ATA operating as a SIP client, the end target may define a network destination resource, such as a SIP endpoint, that is sought to be accessed by a user of the initiation device over the Internet through a proximal computer network through which the initiation device connects to the Internet.

The process through which a VPN connection is initiated in order to establish a connection to a network destination through the VPN begins with the initiation device being directed to or otherwise attempting the access a target network destination. This connection attempt is then held, either because the destination is blocked or because it defines a secure address that requires a secure connection. Then, the initiation device contacts a VPN server and establishes a connection to the VPN server's network. Once connected to the VPN server's network, the initiation device allows the connection to be made to the target network destination through the initiation device's connection the VPN server's network.

It is an object of this invention to provide a system and method for automatically establishing a virtual point-to-point connection with a remote server when a desired port or network address has been blocked for the purposes of establishing a connection to the desired port or address or for the purpose of securing the both the metadata of the communication as well as the actual media stream.

This and other objects will be apparent to one of skill in the art.

### BRIEF DESCRIPTION OF THE DRAWINGS

FIG. 1 shows the components of a system for automatically establishing a SIP connection through a VPN server when a direct connection to a SIP server is unavailable or undesirable in accordance with the present invention.

FIG. 2 shows a process for automatically establishing a SIP connection through a VPN server when a direct connection to a SIP server is unavailable in accordance with the present invention.

FIG. 3 shows a process for selectively establishing a SIP connection through a VPN server when a direct connection to a SIP server fails in accordance with the present invention

### DETAILED DESCRIPTION OF THE INVENTION

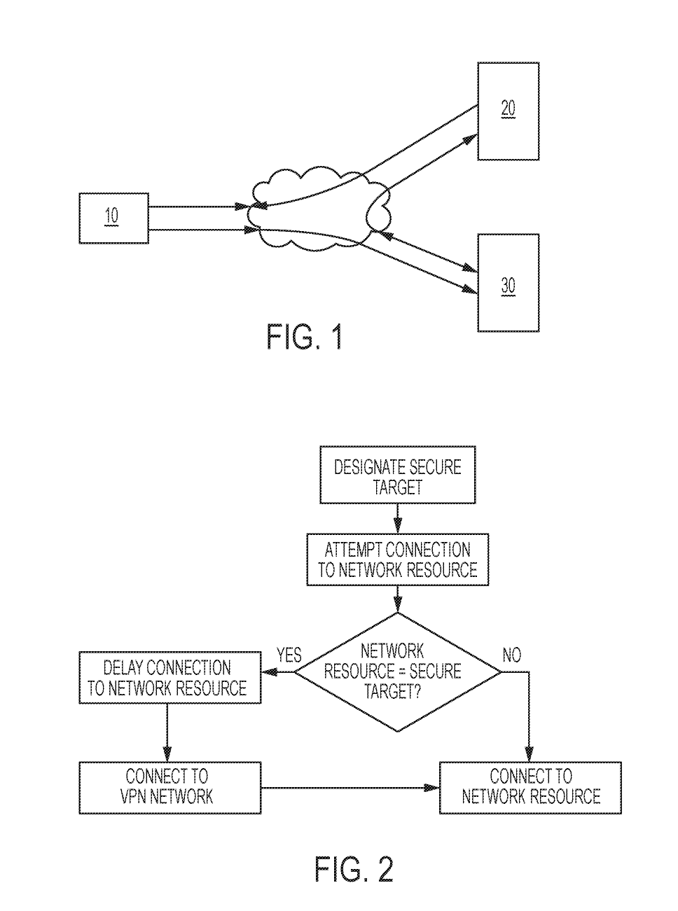

Referring now to the drawings and in particular FIG. 1, a system for automatically initiating a VPN connection for the purposes of establishing an indirect connection to a network resource through the VPN. The system includes an initiation device 10, an end target 20, and a VPN server 30. It is contemplated that the initiation device 10 may define a conventional analog telephone adapter (“ATA”) operating as a SIP client or any network enabled computing device which may be employed to access a desired resource over a computer network.

The end target 20 defines the desired port/Internet Protocol (“IP”) address or network resource (collectively, “network destination”) that is sought to be accessed by a user of the initiation device 10 over a computer network. In the illustrated embodiment, the end target 20 defines a desired SIP endpoint (generally port 5060 or 5061). It is appreciated, however, that in alternate embodiments, the end target 20 may define any specified IP address or network resource with which a network connection is desired.

In the illustrated embodiment, the VPN server 30 defines a conventional VPN provider public network interface that facilitates the availing of remote access to the VPN to authenticated devices. It is contemplated that in some embodiments, there may be a private data connection or a VPN between the VPN server 30 and the end target 20 (as opposed to a public network connection as illustrated).

It is appreciated that by employing a VPN, a user may take advantage of a tunnel networking between a device and a server to go around blocks or restrictions and/or a secure networking that includes encryption so the nature and content of all communications are not easily/readily snooped or otherwise captured.

Referring now to FIGS. 1 and 2, the method for automatically initiating a VPN connection for the purposes of establishing an indirect connection to a network resource through the VPN is illustrated through an example of a blocked SIP port. In this embodiment, the initiation device 10 defines a conventional ATA operating as a SIP client and attempting to access a blocked network resource. It is appreciated that the ATA is caused to perform the steps of the method through instructions contained in software application(s) and/or firmware that are run by a processor in the ATA.

The process through which an integrated VPN connection is automatically initiated for the purposes of establishing a connection to a blocked network resource through the VPN begins with the designation of a secure target or several secure targets on the initiation device 10. In the embodiment illustrated in FIG. 2, a secure target(s) defines as an IP address or network resource to which access has been blocked or otherwise restricted for Internet traffic originating from the network connection (i.e. a local or other spatial area network) available to or used by the initiation device 10 (referred to herein as the “proximal network”). It is contemplated that the secure target locations and VPN configuration parameters (such as server address, login/password, shared secrets or certifications, encryption settings, etc.) may be defined in pre-existing/updated firmware or software on the initiation device 10 or may be manually entered by an end user or an administrator.

Whenever the initiation device 10 connected to its proximal network is directed to connect to an end target 20, it first determines whether of the end target's 20 IP address (or access a network resource) has been designated as a secure target. If the end target's 20 IP address has not been designated as a secure target, the initiation device 10 proceeds to connect to the desired end target 20 through its connection to the proximal network. On the other hand, if the end target's 20 IP address has been designated as a secure target, the initiation device 10 holds the connection attempt, pending the establishment of a connection to the VPN server 30 as detailed below.

Once a connection attempt has been delayed, the initiation device 10 contacts the VPN server 30 through its connection to the proximal network, is authenticated and establishes a connection to the VPN server's 30 network. It is contemplated that if the VPN server's 30 network is connected to a public network, such as the Internet (which is how the initiation device 10 accessed it remotely in the first place), any network enabled device that is connected to the VPN server's 30 network can access such a public network through the VPN server's 30 network. Accordingly, once connected to the VPN server's 30 network, the initiation device 10 releases the hold on the connection attempt to the end target's 20 IP address, allowing the connection to be made through the initiation device's 10 connection the VPN server's 30 network.

In an alternate implementation, the method for automatically initiating a VPN connection for the purposes of establishing an indirect connection to a network resource through the VPN is employed for the addition of security to a communication. In this embodiment, the initiation device 10 defines a conventional ATA operating as a SIP client and attempting to initiate a secured communications session.

The process through which an integrated VPN connection is automatically initiated for the purposes of securing a connection for a communications session through the VPN begins with the designation of a secure target or several secure targets on the initiation device 10. In the embodiment illustrated in FIG. 2, a secure target(s) defines a network destination for which there is a desire to secure a upcoming traffic representing a specific communication (text, voice, video, . . . ) or a network destination for which there is a desire to secure all traffic. It is appreciated that advantageously, by securing all traffic a user can obscure what specific communications may be of value (if you secure only important communications, then it is obvious which communications are important).

Whenever the initiation device 10 connected to its proximal network is directed to connect to an end target 20, it first determines whether of the desired connection involves a secure target. In this case, the secure target may represent a telephone number (or VoIP pointer) or an IP address (or access a network resource) which has been designated as a secure target. If the desired connection does not involve a secure target, the initiation device 10 proceeds to connect to the desired end target 20 through its connection to the proximal network. On the other hand, if the desired connection involves a secure target, the initiation device 10 holds the connection attempt, pending the establishment of a connection to the VPN server 30 in the same manner detailed above.

It is contemplated that the initiation device 10 may include in its memory a listing of network resources that are secure targets. In other embodiments, the initiation device 10 may retrieve over the network a listing of network resources that are secure targets.

It is appreciated that as the data communicated between the initiation device 10 and the VPN server 30 will be encrypted, the network activity through the VPN server's 30 network will not be apparent to the proximal network.

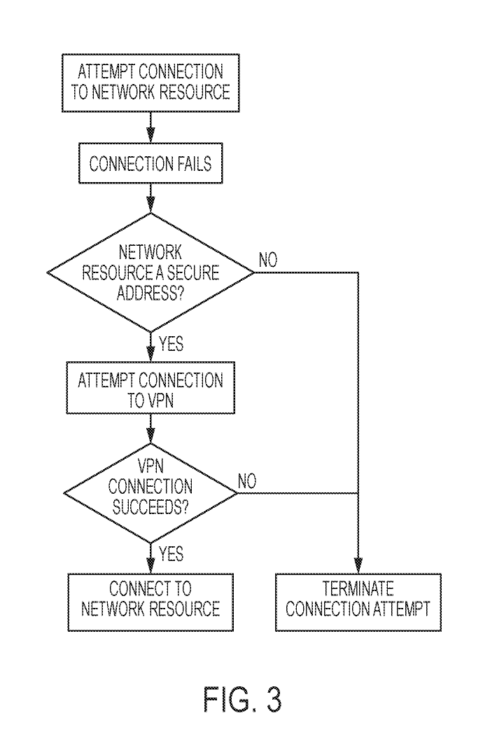

Referring now to FIGS. 1 and 3, the method for selectively initiating a VPN connection for the purposes of establishing an indirect connection to a network resource through the VPN is illustrated through an example of failed connection to an SIP port. In this embodiment, the initiation device 10 again defines a conventional ATA operating as a SIP client and attempting to access a network resource. It is appreciated that the ATA is caused to perform the steps of the method through instructions contained in software application(s) and/or firmware.

The process through which an integrated VPN connection is selectively initiated for the purposes of establishing a connection to a network resource through the VPN begins with the initiation device 10 connected to its proximal network failing in an attempt to connect to a desired end target 20. The initiation device 10 then determines whether of the end target's 20 IP address (or access a network resource) is a secure address. For example, in some embodiments, a secure address may be a SIP address (in others, it could be an Extensible Messaging and Presence Protocol address or a MQTT address). If the end target's 20 IP is not a secure address, the initiation device 10 simply terminates the connection attempt. In the event the end target's 20 IP address is a secure address, the initiation device 10 holds the connection attempt, pending the establishment of a connection to the VPN server 30 in a similar manner to that described above in paragraph 17.

Specifically, the initiation device 10 first contacts the VPN server 30 through its connection to the proximal network, is authenticated and establishes a connection to the VPN server's 30 network. If this process fails, the initiation device 10 simply terminates the connection attempt. Provided it succeeds and the initiation device is connected to the VPN server's 30 network, the initiation device 10 releases the hold on the connection attempt to the end target's 20 IP address, allowing the connection to be made through the initiation device's 10 connection the VPN server's 30 network.

It is contemplated that the VPN server 30 may be set up to use any conventional VPN protocol, such as Point-to-Point Tunneling Protocol, Internet Protocol Security, and Transport Layer Security/Secure Sockets Layer.

In another embodiment, each time the initiation device connected to its proximal network is directed to connect to an end target, it holds the connection and first establishes a connection to a VPN server.

It is contemplated that in some embodiments, the initiation device may include an interface which allows a user to initiate a VPN connection manually prior to attempting to connect to a network resource. In such an embodiment, the initiation device 10 may provide options to the user to directly provide authentication credentials (such as password or passcode, finger print, facial recognition or (iris scan, etc.).

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for initiating a virtual private network connection for the purposes of establishing an indirect connection to a network resource, comprising the steps of:
providing an initiation device having a network interface and adapted to access the Internet through a connection to a computer network;
designating at least one secure target, wherein said at least one secure target defines a network destination to which access has been blocked or otherwise restricted for Internet traffic originating from the computer network;
upon being directed to access a target network destination present on the Internet, determining by the initiation device whether the target network destination has been designated as said at least one secure target or otherwise requires access to said at least one secure target;
upon determining that the target network destination has been designated as the secure target, establishing by the initiation device a connection to a virtual private network server by way of the connection to the Internet through the computer network; and
upon the connection to the virtual private network server being established, connecting by the initiation device to the target network destination through the connection to the virtual private network server.

2. The method of claim 1, wherein the computer network defines a local area network.

3. The method of claim 1, wherein the computer network defines a tier 1 network.

4. The method of claim 1, wherein the computer network defines a tier 2 network.

5. The method of claim 1, wherein the initiation device defines an analog telephone adapter and the target network destination defines a session initiation protocol port.

6. The method of claim 1, wherein the step of connecting occurs automatically following the completion of the step of establishing.

7. The method of claim 6, wherein the initiation device is configured, upon being directed to access the target network destination present on the Internet, to delay any attempt to connect to said target network destination until the completion of the step of establishing.

8. A method for initiating a virtual private network connection for the purposes of establishing an indirect connection to a network resource, comprising the steps of:
providing an initiation device having a network interface and adapted to access the Internet through a connection to a computer network;
upon failing to access a target network destination present on the Internet during an attempt to access the target network destination by way of the Internet through the connection to the computer network, determining by the initiation device whether the target network destination defines a secure address;
upon determining that the target network destination defines the secure address, establishing by the initiation device a connection to a virtual private network server by way of the connection to the Internet through the computer network; and
upon the connection to the virtual private network server being established, connecting by the initiation device to the target network destination through the connection to the virtual private network server.

9. The method of claim 8, wherein the computer network defines a local area network.

10. The method of claim 8, wherein the computer network defines a tier 1 network.

11. The method of claim 8, wherein the computer network defines a tier 2 network.

12. The method of claim 8, wherein the initiation device defines an analog telephone adapter and the target network destination defines a session initiation protocol port.

13. The method of claim 8, wherein the step of connecting occurs automatically following the completion of the step of establishing.

14. The method of claim 13, wherein the initiation device is configured upon failing to access a target network destination present on the Internet during an attempt to access the target network destination, to delay any attempt to connect to said target network destination until the completion of the step of establishing.
